(19) United States
(12) Patent Application Publication
(10) Pub. No.: US 2015/0347293 A1
(43) Pub. Date: Dec. 3, 2015

(54) METHOD AND APPARATUS FOR PREVENTION OF FRAGMENTATION OF NON-VOLATILE MEMORY FOR BLACK BOX DEVICE

(71) Applicants: RESEARCH & BUSINESS FOUNDATION SUNGKYUNKWAN UNIVERSITY, Suwon-si (KR); CENTER FOR INTEGRATED SMART SENSORS FOUNDATION, Daejeon (KR)

(72) Inventors: Dong Kun SHIN, Seoul (KR); Young Hun KIM, Suwon-si (KR); Jin Young YANG, Seoul (KR)

(73) Assignees: RESEARCH & BUSINESS FOUNDATION SUNGKYUNKWAN UNIVERSITY, Suwon-si (KR); CENTER FOR INTEGRATED SMART SENSORS FOUNDATION, Daejeon (KR)

(21) Appl. No.: 14/723,881

(22) Filed: May 28, 2015

(30) Foreign Application Priority Data
May 30, 2014 (KR) 10-2014-0065916

(51) Int. Cl. G06F 12/02

(52) U.S. Cl. CPC G06F 12/0246; G06F 2212/7202

(57) ABSTRACT

In accordance with a first exemplary embodiment, there is provided a device for black box. The device includes one or more camera module; a non-volatile memory, in which a program for operating a file system is stored; and a processor that executes the program stored in the non-volatile memory. Wherein according to execution of the program, the processor divides the whole storage area of the non-volatile memory into a plurality of file storage areas, and stores a file generated by the camera module in one of the plurality of the divided file storage areas according to a type of the file.

### CROSS-REFERENCE TO RELATED APPLICATION

This application claims the benefit of Korean Patent Application No. 10-2014-0065916 filed on May 30, 2014, the disclosures of which are incorporated herein by reference.

### TECHNICAL FIELD

The embodiments described herein pertain generally to a method and an apparatus for prevention of fragmentation of a non-volatile memory for a black box device.

### BACKGROUND

A black box device is equipped in flights, vessels, vehicles or others to record information of images, voice and location, etc., in a nonvolatile memory during driving or upon occurrence of an accident. The information recorded in the black box device is used to investigate causes for an accident when it happens.

The black box device may generate various types of files depending on characteristics of transport facilities. For example, a vehicle black box device equipped in a vehicle generates files for continuous driving, a continuous impact, a parking mode and others. The continuous driving generates files recording image and location information and others of the inside and the outside of the vehicle, which are continuously generated during driving of the vehicle. The continuous impact generates files recording image and location information of the inside and the outside of the vehicle, when an impact happens due to an accident or others during driving of the vehicle. The parking mode generates files recording image information of the inside and the outside of the vehicle when an external movement or an impact is sensed during parking of the vehicle.

This black box device continuously generates files. The files generated in the black box device are stored in a nonvolatile memory included in the black box device. However, a newly generated file may not be stored in the nonvolatile memory equipped in the black box device due to the spatial limit of the nonvolatile memory. In this case, the black box device deletes an identical type of old files depending on types of files, and then, stores a newly generated file.

When the generation and the deletion of files in the black box device are repeated, fragmentation of the nonvolatile memory may occur. In this case, the fragmentation means that a space of a storage device like the nonvolatile memory exists in the form of multiple divided fragments, or data to be stored in a storage device are stored in the form of multiple pieces. If the fragmentation of the nonvolatile memory becomes serious, it may cause decrease of a file reading and writing speed, resulting in problems of decrease of a system processing speed and reduction of the lifetime of the nonvolatile memory.

In this regard, Korean Patent Application Publication No. 10-2011-0121362 (Title of Invention: Data Management Method Capable of Preventing the Fragmentation of a Memory Unit in Memory Pool) describes a method to solve the fragmentation problem by dividing a nonvolatile memory into a plurality of areas, and allocating or releasing different areas depending on sizes of files.

In addition, Korean Patent Application Publication No. 10-2010-0081880 (Title of Invention: Non-volatile Memory, A Page Dynamic Allocation Apparatus, and Pages, Capable of Preventing Memory Fragmentation and a Page Fault) describes a method for preventing a fragmentation phenomenon by dividing a nonvolatile memory into one fixed area and a multiple number of variable areas. This invention stores an operating system and its relevant files in the fixed area, and stores application programs and other files in the variable areas.

Korean Patent Publication No. 1383793 (Title of Invention: Apparatus and Method for Memory Allocating in System On Chip) describes dividing a nonvolatile memory into a dedicated area and a shared area, and using the dedicated area only for a predetermined file when storing a file.

These conventional technologies divide a nonvolatile memory into a multiple number of areas and manage files in the multiple areas in order to solve the fragmentation problem. However, the conventional technologies divide and manage files depending on sizes, uses, and retrievability of files, or manage only predetermined files. Thus, the conventional technologies are not suitable for black box devices, in which files are continuously generated, and cycles of generation and deletion of files vary depending on types of files.

### SUMMARY

In view of the foregoing, example embodiments provide a method for prevention of fragmentation of a nonvolatile memory, which divides a nonvolatile memory into a multiple number of file storage areas to store files, and a black box device, to which the method for prevention of fragmentation of a nonvolatile memory is applied.

However, the problems sought to be solved by the present disclosure are not limited to the above description, and other problems can be clearly understood by those skilled in the art from the following description.

In accordance with a first exemplary embodiment, there is provided a device for black box. The device includes one or more camera module; a non-volatile memory, in which a program for operating a file system is stored; and a processor that executes the program stored in the non-volatile memory. Wherein according to execution of the program, the processor divides the whole storage area of the non-volatile memory into a plurality of file storage areas, and stores a file generated by the camera module in one of the plurality of the divided file storage areas according to a type of the file.

In accordance with a second exemplary embodiment, there is provided a method for operating a file system in a black box device. The method includes dividing a whole storage area of a non-volatile memory included in the black box device into a plurality of file storage areas; selecting a file storage area from the file storage areas, when a file to be recorded in the non-volatile memory is input, based on a type of the file; and storing the file in the selected file storage area.

According to one of the foregoing technical means, the example embodiments provide a method for prevention of fragmentation of a nonvolatile memory in a black box device, in which writing and deletion of files frequently occur, and as a result, can expect various ripple effects throughout the relevant business fields.

The example embodiments can prevent fragmentation of a nonvolatile memory, and reduce the number of times for reading and writing of files in a nonvolatile memory. As a result, the example embodiments can reduce errors of the nonvolatile memory, and increase the lifetime of the nonvolatile memory having the fixed number of recording times. Further, the example embodiments can prevent decrease of a processing speed of a black box device resulting from frequent reading and writing of files. Accordingly, the example embodiments can expect improvement of performance of a black box device and increase of reliability thereof.

### BRIEF DESCRIPTION OF THE DRAWINGS

FIG. 1 is a configuration diagram schematically illustrating a black box device in accordance with an example embodiment.

FIG. 2 is a flow chart illustrating a method for operating a file system in the black box device in accordance with an example embodiment.

FIG. 3 is a flow chart illustrating a process, in which when a file to be stored in a nonvolatile memory of a black box device in accordance with another example embodiment is input, a file storage area, in which the file will be stored, is selected, and the file is stored therein.

FIG. 4 is an exemplary diagram for depicting a method for storing a file in a conventional common black box device.

FIG. 5A is an exemplary diagram for depicting a file storage area and file system information of the conventional common black box device.

FIG. 5B is an exemplary diagram for depicting a file storage area and file system information of the conventional common black box device.

FIG. 6A is an exemplary diagram for depicting file system information of the black box device in accordance with an example embodiment.

FIG. 6B is an exemplary diagram for depicting a file storage area of the black box device in accordance with an example embodiment.

FIG. 7 is an exemplary diagram for depicting a process for storing a file in the black box device in accordance with an example embodiment.

### DETAILED DESCRIPTION

Hereinafter, example embodiments will be described in detail with reference to the accompanying drawings so that inventive concept may be readily implemented by those skilled in the art. However, it is to be noted that the present disclosure is not limited to the example embodiments but can be realized in various other ways. In the drawings, certain parts not directly relevant to the description are omitted to enhance the clarity of the drawings, and like reference numerals denote like parts throughout the whole document.

Throughout the whole document, the terms “connected to” or “coupled to” are used to designate a connection or coupling of one element to another element and include both a case where an element is “directly connected or coupled to” another element and a case where an element is “electronically connected or coupled to” another element via still another element. Further, the term “comprises or includes” and/or “comprising or including” used in the document means that one or more other components, steps, operations, and/or the existence or addition of elements are not excluded in addition to the described components, steps, operations and/or elements.

In addition, in describing the example embodiments with reference to the drawings, the same component may be denoted by different drawing reference numerals depending on the drawings, and the drawing reference numerals are used merely for convenience of description, and a concept, characteristics and effects of each component should not be restrictively construed by its corresponding drawing reference numeral.

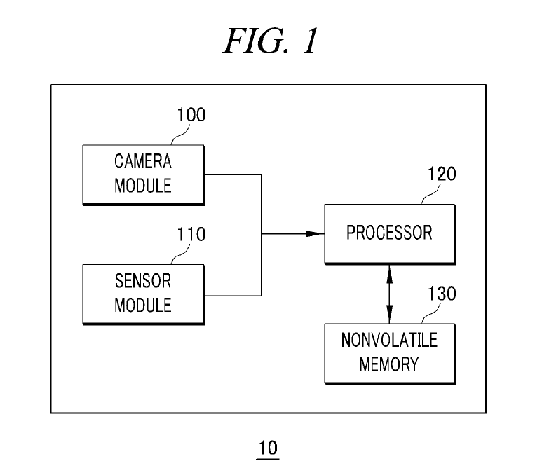

First, a black box device 10 in accordance with an example embodiment is described with reference to FIG. 1.

FIG. 1 is a configuration diagram schematically illustrating the black box device 10 in accordance with an example embodiment.

The black box device 10 commonly refers to a device mounted in a transport facility to record information. For example, the black box device 10 may include any type of a transport facility recorder such as a flight data recorder (FDR), a voyage data recorder (VDR) and an event data recorder (EDR). In this case, the flight data recorder may be mounted in a flight to record the state of the flight, voice information of a control station, and voice information that has recorded communication contents. The voyage data recorder may be mounted in a vessel to record the operation state of various types of nautical instruments, transmission and reception contents of communication equipment, image or voice information of the inside of the wheelhouse. The event data recorder may be mounted in a car to record image information of the inside and the outside of the car and voice information that has recorded voice in the inside of the car, when an event happens.

The black box device 10 may include one or more camera modules 100, a nonvolatile memory 130, in which a program for operating a file system is stored, and a processor 120 for executing the program stored in the nonvolatile memory 130.

The nonvolatile memory 130 commonly refers to a storage device that continuously holds stored information even when no supply is provided.

The program stored in the nonvolatile memory 130 may function as an operating system that operates a file system, to which the example embodiments are applied, or be executed in the form of a firmware or application equipped with a file system, to which the example embodiments are applied.

The camera module 100 may include one or more lenses, an image sensor and others. The camera module 100 photographs images, pictures, videos and others of the inside and the outside of a vehicle or the like by using the lens and the image sensor and converts the photographed images, pictures, videos and others into digital files. In this case, the files generated through the camera module 100 is stored in the nonvolatile memory 130.

The processor 120 may classify types of files generated through the camera module 100 in the black box device 10, according to execution of the program stored in the nonvolatile memory 130. The processor 120 may divide the whole storage area of the nonvolatile memory 130 into a multiple number of file storage areas based on the classified types of files.

Once a file is generated through the camera module 100, the processor may store the generated file in one of the multiple file storage areas of the nonvolatile memory 130 according to the type of the file. In this case, the file storage area corresponding to the generated file may be a file storage area, in which an identical or similar type of a file to the generated file will be stored.

Meanwhile, the black box device 10 may further include one or more sensor modules 110. In this case, the sensor module 110 implementing sensing in the black box device 10 may include a motion sensor, a position sensor and others. For example, the motion sensor may include any type of a motion-based sensor for determining driving or parking of a vehicle or sensing events such as an accident in the black box device 10, like an accelerometer sensor, a G-sensor, or a gyroscope sensor. In addition, the position sensor may include any type of a position-based sensor capable of sensing a current position, a driving direction or others of a vehicle and others, like a global positioning system (GPS) or a geomagnetic sensor.

The processor 120 may classify a type of a sensor information file, such as an event information file and a position information file, generated through the sensor module 110, according to execution of the program stored in the nonvolatile memory 130. Also, the processor 120 may store the generated sensor information file in one of the multiple file storage areas of the nonvolatile memory 130 according to the classified type of the file. In this case, the processor 120 may use the classification criteria for the sensor information file as criteria for classifying types of files generated in the camera module 100. In the case where a file and a sensor information file are classified into an identical file type, the processor 120 may store the file and the sensor information file in an identical file storage area.

The processor 120 in accordance with the example embodiments may use meta information in order to classify types of files such as the files or the sensor information files generated in the black box device 10. Meta information of a file generated in the black box device 10 may include generation time, a storage category, a name, a size and others of the file. The black box device 10 may classify a type of a file by analyzing meta information of the file.

In addition, when different two files are stored in a file category regarding similar or identical generation time, the processor 120 may classify the files into an identical file type. For example, when a random file and a random senor information file are generated at an identical time, and stored in an identical file category, the processor 120 may classify the two files into an identical file type.

Types of files classified by the processor 120 may be one of a continuous driving image, a continuous impact image and a parking mode image. For example, in the car black box device 10, the continuous driving image includes a continuous driving image file and a sensor information file of the inside and the outside of the car during driving.

Of the file types generated in the car black box device 10, the continuous driving image is the most frequently generated. However, the continuous driving image may be less likely to be used for accident investigation upon occurrence of an accident. Thus, when the storage space of the nonvolatile memory 130 is not enough, the processor 120 may delete a continuous driving image, which is unlikely to be used as a certain period of time or longer lapses from generation of the file, in order to store a newly generated file.

On the other hand, the continuous image stores a file and a sensor information file of the inside and the outside of a vehicle, when an impact occurs by an accident or the like during driving of the vehicle. Unlike the continuous driving image, the continuous impact image is highly likely to be used for accident investigation when an accident occurs. Thus, the processor 120 may not delete the continuous impact image even when the storage space of the nonvolatile memory 130 is not enough.

The parking mode image records image information of the inside and the outside of a vehicle, when external movement or an impact on a vehicle is sensed during parking of the vehicle. In this case, since the parking mode image, like the continuous impact image, is highly likely to be used for accident investigation, it may not be deleted even when the storage space of the nonvolatile memory 130 is not enough.

Meanwhile, the file storage areas of the nonvolatile memory 130 may include not only file storage areas, which are classified according to file types, but also a shared area capable of storing any types of files. Thus, when a space of a file storage area selected for storage of a file in the nonvolatile memory 130 is not enough, the processor 120 may store the file by using part of the shared area as the space of the file storage area.

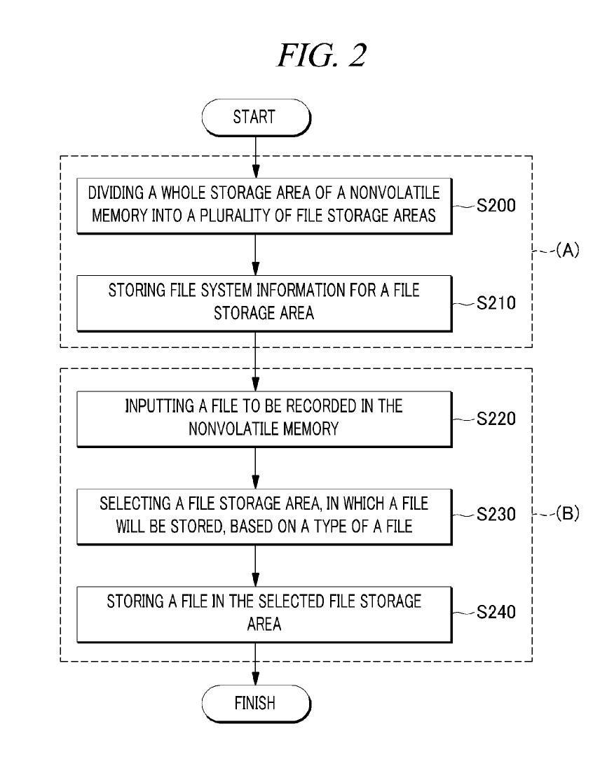

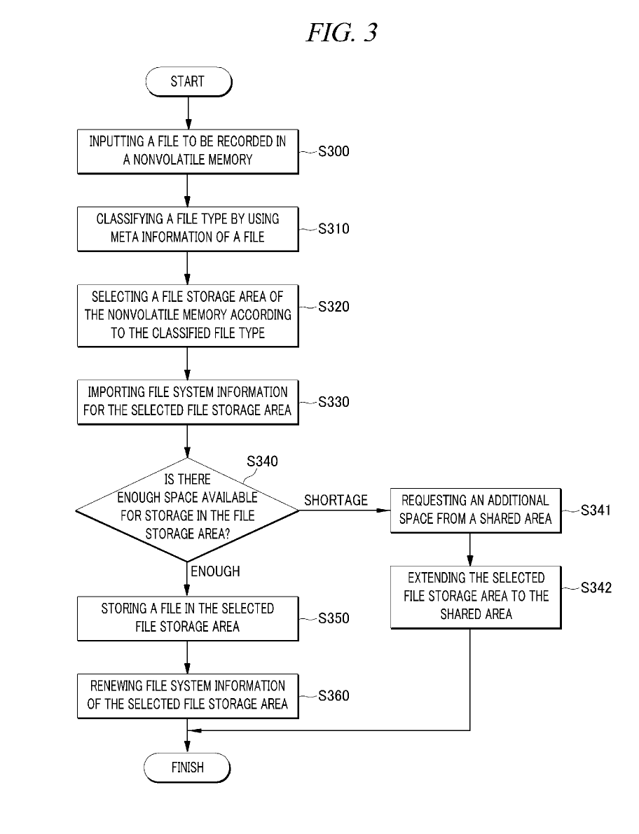

Next, a method for operating a file system in the black box device 10 is described with reference to FIG. 2 and FIG. 3.

FIG. 2 is a flow chart illustrating a method for operating a file system in the black box device 10 in accordance with an example embodiment.

As shown in (A) of FIG. 2, the black box device 10 in accordance with an example embodiment first divides the whole storage area of the nonvolatile memory 130 of the black box device 10 into a multiple number of file storage areas (S200).

After the division of the file storage area (S200), the black box device 10 may store file system information in the divided file storage area (S210). In this case, the file system information may include a starting position, a finish position, a size and the latest use position of the file storage area. The latest use position of the file storage area may vary depending on the storage and the deletion of files.

The file storage area of the nonvolatile memory 130 may be divided to fit in a size of a block of the nonvolatile memory 130. The nonvolatile memory 130 has a characteristic of reading and writing a file in a block unit. Thus, if the file storage area of the nonvolatile memory 130 is divided to fit in the size of the block, two or more areas may not be allocated to one block at the same time. The black box device 10 can reduce the number of times for unnecessary file reading/writing in the nonvolatile memory 130 having the above-described characteristic. Further, the black box device 10 can reduce fragmentation of the nonvolatile memory 130 and increase the lifetime thereof.

The black box device 10 may take into account types of files generated in the black box device 10 in order to divide the file storage area (S200). The black box device 10 may classify types of files by analyzing file characteristics by using meta information such as the file or the sensor information file generated in the black box device 10, and grouping similar files. In this case, types of files may be classified into one of the continuous driving image, the continuous impact image, and the driving mode image.

In order to classify types of files, the black box device 10 may use meta information of a file. In this case, meta information of a file may include generation time, a storage category, a name, a size and others of the file. For example, when a storage category of a random video file includes a specific word having a meaning of parking, the black box device 10 may classify the video file into the parking mode image. In addition, if there is a sensor information file prepared at a similar time to that of the video file that has been classified into the parking mode image, the black box device 10 may also classify the corresponding information file into the parking mode image.

In addition, in order to divide the file storage area (S200), the black box device 10 may generate a shared area capable of storing any types of files. In this case, the shared area may be used when the storage space of the file storage area is not enough. Since the black box device 10 divides the space of the nonvolatile memory 130 into a multiple number of areas and manages the areas, there may be a case where while the whole nonvolatile memory 130 has enough free space, a certain area thereof has no enough free space. Thus, the black box device 10 can solve this problem by providing the shared area in the nonvolatile memory 130. Thus, when a file is stored in the nonvolatile memory 130, if a storage space of a selected file storage area is not enough, the black box device 10 may use part of the shared area as the storage area of the selected file storage area.

In addition, after the creation of the free space of the selected file storage area, the black box device 10 may return the shared area that has been being used. As described, the black box device 10 can solve the problem of lack of a free space in a certain area by providing the shared area in the file storage area, and limit the file fragmentation problem to the shared area.

After the division of the file storage area, the black box device 10 may store file system information (S220). In this case, the information of the file system may include a starting position, a finish position, a size and the latest use position of the file storage area.

Meanwhile, once a file to be recorded in the nonvolatile memory 130 is input, the black box device 10 classifies a type of the input file. Based on the classified type of the file, the black box device 10 selects a file storage area, in which the input file will be stored, from the divided multiple file storage area (S230). Once a file storage area is selected, the black box device 10 stores the file to be recorded in the nonvolatile memory 130 in the selected file storage area (S240).

Specifically, once a file to be recorded in the nonvolatile memory 130 is input, the black box device 10 may select a file storage area, in which the input file will be stored, from the divided multiple file storage areas based on a type of the file (S230). In this case, the black box device 10 may classify a type of the file to be recorded in the nonvolatile memory 130, and select a file storage area by using the above-described meta information.

In addition, the black box device 10 may compare and analyze a finish position and the latest use position of the file system information for the selected file storage area to determine whether the file storage space is enough, prior to storage of the input file. If the file storage space is not enough, the black box device 10 may use the shared area, in order to store the input file.

If a file storage area is selected, and a storage space thereof is enough, the black box device 10 may store a file in the selected file storage area (S240). After the storage of the file, the black box device 10 may renew the latest use position of the file system information of the selected file storage area.

Next, a method that enables the file system in the black box device 10 to store a file in accordance with another example embodiment is described.

FIG. 3 is a flow chart illustrating a process, in which when a file to be stored in the nonvolatile memory 130 of the black box device 10 in accordance with another example embodiment is input, a file storage area, in which the file will be stored, is selected, and the file is stored therein.

Once a file to be recorded in the nonvolatile memory 130 is input (S300), the black box device 10 may classify a type of the file by using meta information of the file (S310). In addition, the black box device 10 may select a file storage area of the nonvolatile memory 130 according to the classified type of the file (S320). Once the file storage area is selected, the black box device 10 may import file system information for the selected file storage area (S330).

The black box device 10 may analyze the file system information of the selected file storage area (S340) and store the file in the selected file storage area if the storage space is enough (S350).

However, if the storage space is not enough, the black box device 10 may request an additional space from the shared area (S341). In addition, the black box device 10 may expand the selected file storage area to the shared area (S342), and then, store the file in the selected file storage area (S350).

After the storage of the file is finished, the black box device 10 may renew the information of the file system of the selected file storage area (S360).

In this case, the black box device 10 may classify a type of the file into one of the continuous driving image, the continuous impact image and the parking mode image by using meta information of the file through the above-described method.

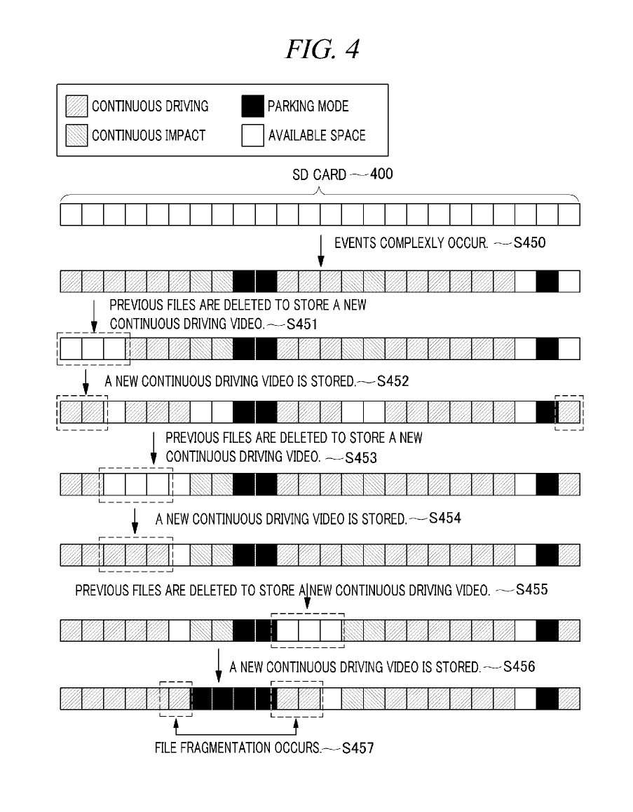

Next, a file storing method of a conventional common black box device and the file storing method of the black box device 10 in accordance with an example embodiment are described with reference to FIG. 4 to FIG. 6B.

FIG. 4 is an exemplary diagram for depicting a file storing method in a conventional common black box device.

A nonvolatile memory 400 in the conventional common black box device uses the whole file storage area for file storage. In order to store a file generated in the conventional black box device, the file system of the conventional black box device finds spaces in the whole file storage area of the nonvolatile memory 400, sequentially allocates the spaces, and stores the file in the allocated spaces.

For example, when events of the continuous driving, the continuous impact, and the parking mode complexly occurs in the conventional black box device (S450), the conventional black box device stores the files in the nonvolatile memory 400 in the order of generation of the files. When a new continuous driving image file is input, the conventional black box device searches an empty space in the nonvolatile memory 400, and if there is no empty space, the conventional black box device deletes an existing file fitting in the size of the image in order to store the driving image file (S451). In addition, the conventional black box device sequentially allocates the remaining spaces, and then, stores the new continuous driving image (S452). When another continuous driving image file is input, the conventional black box device deletes an existing file fitting in the size of the image (S453), sequentially allocates the remaining spaces, and then, stores the new continuous driving image (S454).

As described, the conventional black box device deletes an existing file in order to store a new file, sequentially allocates the remaining spaces, and then, stores a new file. Thus, in the conventional black box device, file fragmentation may occur so that a file cannot be stored in consecutive spaces of the nonvolatile memory 400 (S457).

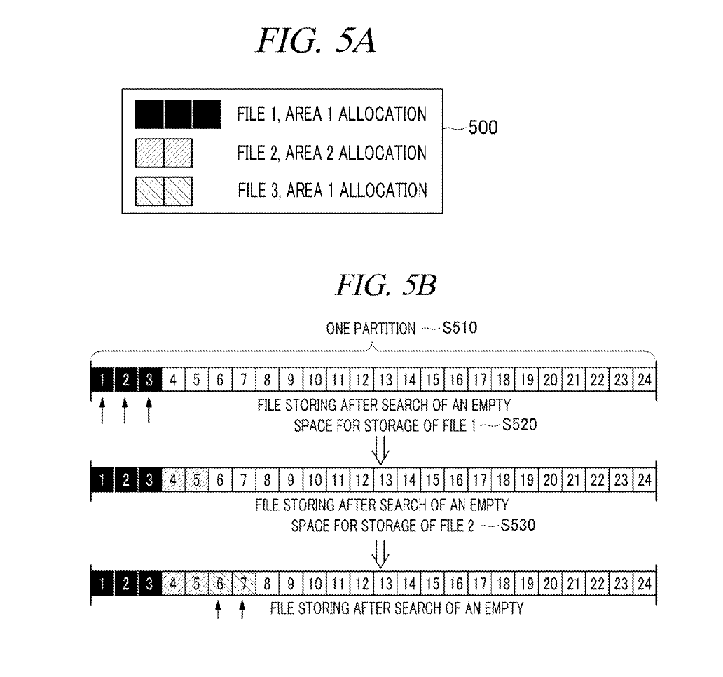

FIG. 5A and FIG. 5B are exemplary diagrams for depicting the file storage area and the file system information of the conventional common black box device.

If File 1 illustrated in FIG. 5A is stored in the whole space of a nonvolatile memory 510 configured by one identical partition, the conventional black box device may store File 1 in 1^{st} to 3^{rd} blocks of the nonvolatile memory 510 (S520). Next, if the conventional black box device stores File 2 of FIG. 5A in the nonvolatile memory 510, the conventional black box device stores File 2 in 4^{th} and 5^{th} blocks of the nonvolatile memory 510 (S530). Finally, the conventional black box device may store File 3 of FIG. 5A in 6^{th} and 7^{th} blocks of the nonvolatile memory 510 (S540). Accordingly, the conventional black box device sequentially stores a file in the nonvolatile memory 510 according to the order of storage, regardless of types of the file.

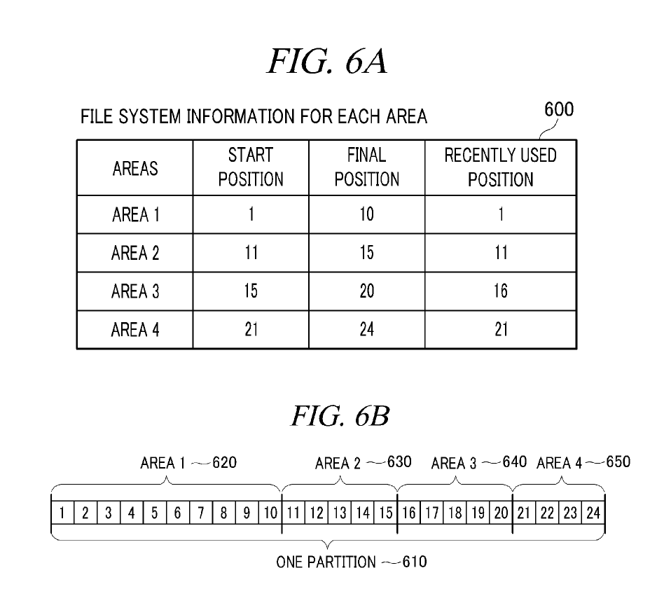

However, the black box device 10 in accordance with an example embodiment may store files in their corresponding file storage areas, according to types of the files to be stored. The black box device 10 is described in detail with reference to FIG. 6A and FIG. 6B.

FIG. 6A is an exemplary diagram for depicting the file system information of the black box device 10 in accordance with an example embodiment. FIG. 6B is an exemplary diagram for depicting the file storage area of the black box device 10 in accordance with an example embodiment.

The black box device 10 may divide the nonvolatile memory 610 configured by one identical partition into four file storage areas (620, 630, 640 and 650) according to the types of files that are used for the file storage area classification in the black box device 10. In this case, the black box device 10 stores a starting position, the latest position, and information of the nonvolatile memory 610 with respect to each of the file storage areas in the file system information 600. After storing a new file in a random area of the nonvolatile memory 610, the black box device 10 may renew the latest use position of the file system information 600 with respect to the corresponding area.

For example, once the file system stores three block-size files in Area 2 (630), the latest use position of the file system information 600 with respect to Area 2 (630) is renewed from 11 to 13.

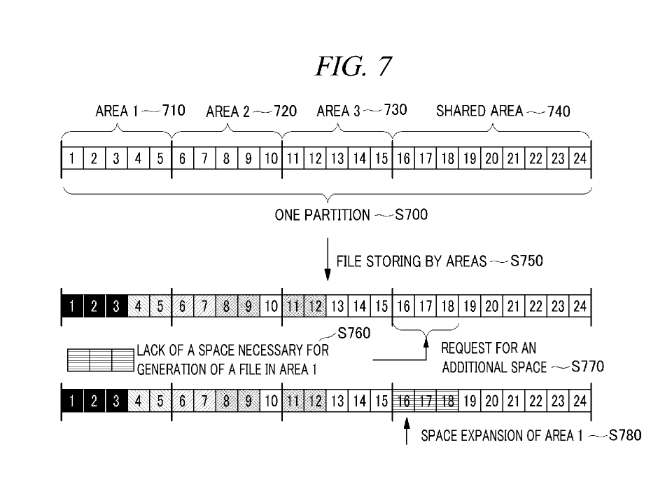

FIG. 7 is an exemplary diagram showing a process, in which the black box device 10 stores a certain file in accordance with an example embodiment.

The black box device 10 in accordance with an example embodiment may divide one partition 700 of the nonvolatile memory 130 into three file storage areas 700, 710 and 720 and one shared area 730. After the division, the black box device 10 may classify types of files generated and stored in the black box device 10 and store the files in their corresponding areas.

For example, File 1 of FIG. 7 is stored in 1^{st} to 3^{rd} blocks of Area 1 (700) in the nonvolatile memory 130. File 2 of FIG. 7 is stored in 6^{th} and 7^{th} blocks of Area 2 (710). File 3 of FIG. 7 is stored again in 4^{th} and 5^{th} blocks of Area 1 (700).

After the storage of files by areas (S750), the black box device 10 may store a new file in Area 1. In this case, since Area 1 has no free space for storing the new file, the black box device 10 requests an additional space from the shared area (S770). In addition, the black box device 10 is allocated the additional area for storing the new file, and then, stores the new file in the shared area (S780).

The method and the apparatus 10 for prevention of fragmentation of the nonvolatile memory 130 for the black box device in accordance with an example embodiment may prevent fragmentation of the nonvolatile memory 130, so as to reduce the number of times for file reading and writing in the nonvolatile memory 130. As a result, the method and the apparatus 10 for prevention of fragmentation may reduce errors of the nonvolatile memory 130, and increase the lifetime of the nonvolatile memory 130 having the fixed number of times for recording.

Further, the method and the apparatus 10 for prevention of fragmentation may prevent decrease of a processing speed of the black box device 10 resulting from the frequent file reading and writing. Accordingly, the method and the apparatus 10 for prevention of fragmentation may expect improvement of performance and increase of reliability of the black box device 10.

The example embodiments can be embodied in a storage medium including instruction codes executable by a computer or processor such as a program module executed by the computer or processor. A computer readable medium can be any usable medium which can be accessed by the computer and includes all volatile/nonvolatile and removable/non-removable media. Further, the computer readable medium may include all computer storage and communication media. The computer storage medium includes all volatile/nonvolatile and removable/non-removable media embodied by a certain method or technology for storing information such as computer readable instruction code, a data structure, a program module or other data. The communication medium typically includes the computer readable instruction code, the data structure, the program module, or other data of a modulated data signal such as a carrier wave, or other transmission mechanism, and includes information transmission mediums.

The method and the system of the example embodiments have been described in relation to the certain examples. However, the components or parts or all the operations of the method and the system may be embodied using a computer system having universally used hardware architecture.

The above description of the example embodiments is provided for the purpose of illustration, and it would be understood by those skilled in the art that various changes and modifications may be made without changing technical conception and essential features of the example embodiments. Thus, it is clear that the above-described example embodiments are illustrative in all aspects and do not limit the present disclosure. For example, each component described to be of a single type can be implemented in a distributed manner. Likewise, components described to be distributed can be implemented in a combined manner.

The scope of the inventive concept is defined by the following claims and their equivalents rather than by the detailed description of the example embodiments. It shall be understood that all modifications and embodiments conceived from the meaning and scope of the claims and their equivalents are included in the scope of the inventive concept.

We claim:

1. A black box device, comprising:
one or more camera module;
a non-volatile memory, in which a program for operating a file system is stored; and
a processor that executes the program stored in the non-volatile memory,
wherein according to execution of the program, the processor divides the whole storage area of the non-volatile memory into a plurality of file storage areas, and stores a file generated by the camera module in one of the plurality of the divided file storage areas according to a type of the file.

2. The black box device of claim 1, further comprising
one or more sensor module that implements sensing,
wherein the processor classifies a type of a sensor information file generated through the sensor module, and stores the classified sensor information file in one of the plurality of the divided file storage areas according to the type of the sensor information file.

3. The black box device of claim 1,
wherein the processor classifies the type of the file by using meta information of the file, and
the type of the file is classified into one of a continuous driving image, a continuous impact image and a parking mode image.

4. The black box device of claim 1,
wherein the file storage area comprises a shared area that can store any type of a file, and
if a space of a file storage area selected for the storage is not enough, the processor uses part of the shared area as the space of the file storage area selected for the storage.

5. A method for operating a file system in a black box device, comprising:
dividing a whole storage area of a non-volatile memory included in the black box device into a plurality of file storage areas;
selecting a file storage area from the file storage areas, when a file to be recorded in the non-volatile memory is input, based on a type of the file; and
storing the file in the selected file storage area.

6. The method for operating a file system as claimed in claim 5,
wherein the step of dividing the file storage area comprises storing file system information for the file storage area, and
the file system information includes a starting position, a finish position, a size and the latest use position of the file storage area.

7. The method for operating a file system as claimed in claim 5,
wherein the step of dividing the file storage area divides the size of the file storage area to fit in the size of the non-volatile memory block.

8. The method for operating a file system as claimed in claim 5,
wherein the step of selecting the file storage area comprises classifying a type of a file by using meta information of the file, and
the type of the file is classified into one of a continuous driving image, a continuous impact image and a parking mode image.

9. The method for operating a file system as claimed in claim 5,
wherein the step of dividing the file storage area comprises generating a shared area that can store any type of a file, and
if a space of the file storage area selected for storing the file is not enough, the step of selecting the file storage area stores the file by using part of the shared area as the space of the file storage area.

10. The method for operating a file system as claimed in claim 5,
wherein the step of storing the file renews the file system information of the file storage area, in which the file has been stored.
